(19) United States
(12) Patent Application Publication
(10) Pub. No.: US 2017/0073526 A1
(43) Pub. Date: Mar. 16, 2017

(54) PROTECTIVE COATINGS INCLUDING PARTIALLY HALOGENATED MATERIALS AND METHODS FOR FORMING AND USING SAME

(71) Applicant: EMPIRE TECHNOLOGY DEVELOPMENT LLC, Wilmington, DE (US)

(72) Inventor: Christopher Alfred CARLSON, Salt Lake City, UT (US)

(73) Assignee: EMPIRE TECHNOLOGY DEVELOPMENT LLC, Wilmington, DE (US)

(21) Appl. No.: 15/309,393

(22) PCT Filed: May 5, 2014
(86) PCT No.: PCT/US14/36768

§ 371 Date: Nov. 7, 2016

(51) Int. Cl. C09D 5/08; C09D 127/16; B05D 1/04; B05D 1/28; B05D 1/02; B05D 1/22; C09D 181/02; C09D 127/18

(52) U.S. Cl. CPC C09D 5/08; C09D 181/02; C09D 127/16; C09D 127/18; B05D 1/28; B05D 1/02; B05D 1/22; B05D 1/04

(57) ABSTRACT

Protective coatings and methods for applying the same are described. A protective coating may be formed on a substrate to reduce or eliminate corrosion or other damage to the substrate. The protective coating may include at least one primer layer applied onto the substrate. The at least one primer layer may include polyphenylene sulfide. The at least one primer layer may be formed from polyphenylene sulfide and a partially halogenated material. At least one intermediate layer may be applied onto the at least one primer layer. The intermediate layer may include polyphenylene sulfide and a partially halogenated material. At least one top layer may be applied onto the at least one intermediate layer. The at least one top layer may consist essentially of a partially halogenated material. The at least one top layer may include polyphenylene sulfide and a partially halogenated material.

### BACKGROUND

Chemical storage and manufacturing processing equipment are constantly exposed to harsh conditions, such as reactive chemicals, heat, and moisture. As such, vulnerable surfaces of such equipment have often been coated with polymer materials to reduce corrosion and other forms of damage. Illustrative polymer materials include urethane, acrylic materials, latex, epoxies, organo-silanes. Conventional applications of polymer materials generally require numerous layers, for example, 25 or more layers. In addition, each application may require an individual heating, drying, and/or curing step. Thus, such applications are labor intensive and are often prone to failure. In addition, conventional coatings have an inadequate lifespan such that re-application of the polymer materials occurs frequently. As such, the efficiency and cost-effectiveness of chemical storage and manufacturing processes are dependent on the rate of corrosion of the equipment, such as storage tanks, mixing vessels, pipes, or the like.

Conventional techniques to manage corrosion involve the constant replacement of corroded parts, or constructing components from corrosive resistant materials, which can be expensive and largely ineffective. It will therefore be desirable to reduce corrosion in chemical storage and manufacturing systems in a manner that minimizes the economic impact of corrosion through protective coatings that have a cost-effective application process and a substantially increased life-span.

### SUMMARY

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of coating a substrate to protect a surface thereof may include coating the surface of the substrate with at least one primer layer. The at least one primer layer may include about 0% by weight to about 20% by weight of a first partially halogenated material and about 80% by weight to about 100% by weight of polyphenylene sulfide. The at least one primer layer may be coated with at least one intermediate layer that includes about 60% by weight to about 80% by weight of a second partially halogenated material and about 20% by weight to about 40% by weight of polyphenylene sulfide. The at least one intermediate layer may be coated with at least one top layer that includes about 80% by weight to about 100% by weight of a third partially halogenated material and about 0% by weight to about 20% by weight of polyphenylene sulfide.

In an embodiment, a substrate may have at least one surface coated with a protective coating that includes at least one primer layer applied thereon. The at least one primer layer may include about 0% by weight to about 20% by weight of a first partially halogenated material and about 80% by weight to about 100% by weight of polyphenylene sulfide. At least one intermediate layer may be applied onto the at least one primer layer.

The at least one intermediate layer may include about 60% by weight to about 80% by weight of a second partially halogenated material and about 20% by weight to about 40% by weight of polyphenylene sulfide. At least one top layer may be applied onto the at least one intermediate layer. The at least one top layer may include about 80% by weight to about 100% by weight of a third partially halogenated material and about 0% by weight to about 20% by weight of polyphenylene sulfide.

In an embodiment, a method of forming a protective coating may include providing at least one primer layer that includes about 0% by weight to about 20% by weight of a first partially halogenated material and about 80% by weight to about 100% by weight of polyphenylene sulfide. At least one intermediate layer may be provided on the at least one primer layer. The at least one intermediate layer may include about 60% by weight to about 80% by weight of a second partially halogenated material and about 20% by weight to about 40% by weight of polyphenylene sulfide. At least one top layer may be provided on the at least one intermediate layer. The at least one top layer may include about 80% by weight to about 100% by weight of a third partially halogenated material and about 0% by weight to about 20% by weight of polyphenylene sulfide. The at least one primer layer, the at least one intermediate layer, and the at least one top layer may be formed into the protective coating.

In an embodiment, a protective coating may include at least one primer layer comprising about 0% by weight to about 20% by weight of a first partially halogenated material and about 80% by weight to about 100% by weight of polyphenylene sulfide. The protective coating may include at least one intermediate layer including about 60% by weight to about 80% by weight of a second partially halogenated material and about 20% by weight to about 40% by weight of polyphenylene sulfide. The protective coating may include at least one top layer including about 80% by weight to about 100% by weight of a third partially halogenated material and about 0% by weight to about 20% by weight of polyphenylene sulfide.

In an embodiment, a kit of components for forming a protective coating may include a primer layer component including about 0% by weight to about 20% by weight of a first partially halogenated material and about 80% by weight to about 100% by weight of polyphenylene sulfide. The kit may include an intermediate layer component including about 60% by weight to about 80% by weight of a second partially halogenated material and about 20% by weight to about 40% by weight of polyphenylene sulfide. The kit may include a top layer component comprising about 80% by weight to about 100% by weight of a third partially halogenated material and about 0% by weight to about 20% by weight of polyphenylene sulfide.

### BRIEF DESCRIPTION OF THE DRAWINGS

FIG. 1 depicts an illustrative substrate having a protective coating formed thereon according to some embodiments.

FIG. 2 depicts an illustrative substrate having a protective coating formed thereon according to some embodiments.

FIG. 3 depicts a flow diagram for an illustrative method of forming a protective coating according to a first embodiment.

FIG. 4 depicts a flow diagram for an illustrative method of forming a protective coating according to a second embodiment.

### DETAILED DESCRIPTION

The terminology used in the description is for the purpose of describing the particular versions or embodiments only, and is not intended to limit the scope.

The described technology generally relates to protective coatings. The protective coatings may be applied to a substrate to reduce or eliminate corrosion of the substrate and/or to provide a chemically inert surface. The protective coatings may be configured to provide a physical barrier between a substrate and one or more corrosive substances, shielding the substrate from chemical and/or thermal breakdown and prolonging the useful life of an apparatus or piece of equipment formed from the substrate. The substrate may include a wall of a vessel or piece of equipment exposed to chemicals, heat, steam, or the like during a process. The protective coatings may include at least one primer layer, at least one intermediate layer applied onto the at least one primer layer, and at least one top layer applied onto the at least one intermediate layer. In some embodiments, the at least one primer layer may be applied onto a surface of the substrate. In some embodiments, the at least one primer layer may be applied onto an initial primer layer, such as a cobalt oxide primer layer, coating the surface of the substrate. The layers of the protective coating may be formed from various materials, including partially halogenated materials and polyphenylene sulfide.

Use of the described technology can result in a reduction or elimination of corrosion in system components coated with a protective coating relative to operation of the same or similar system components without the described methods and materials. The degree of corrosion can generally be reduced by any amount. For example, the degree of corrosion can be reduced by at least about 10%, at least about 20%, at least about 30%, at least about 40%, at least about 50%, at least about 60%, at least about 70%, at least about 80%, at least about 90%, at least about 95%, at least about 96%, at least about 97%, at least about 98%, at least about 99%, and in an ideal situation, about 100% reduction (complete elimination of corrosion).

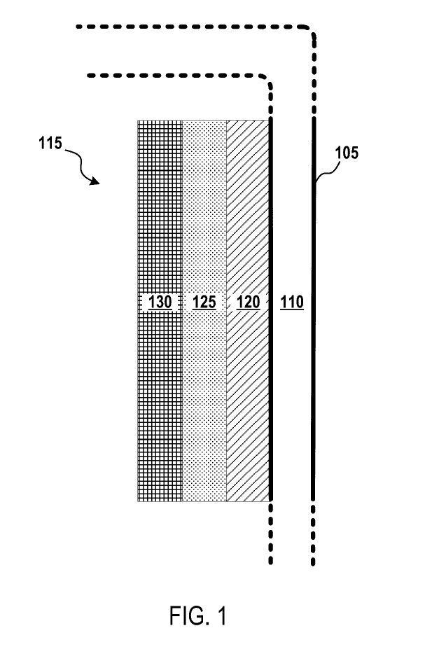

FIG. 1 depicts an illustrative substrate having a protective coating formed thereon according to some embodiments. As shown in FIG. 1, an apparatus 105 may include a substrate 110 coated with a protective coating 115. The apparatus may include various apparatuses, pieces of equipment, and components thereof. Illustrative apparatuses 105 may include, without limitation, a chemical holding tank, a chemical mixing tank, a water tank, a mixing apparatus, processing equipment, manufacturing equipment, material handling equipment, fluid piping, or the like. The substrate 110 may include a surface or wall of the apparatus 105. The substrate 110 may be formed from any material capable of being treated with a protective coating 115 according to some embodiments. Illustrative substrates 110 may include metal, aluminum, stainless steel, iron, a ceramic material, an alloy of any of the foregoing, and a combination thereof. The protective coating 115 may provide various levels of protection for the substrate. For example, the protective coatings 115 may be configured to pass the United States Pharmacopeia (USP) Class VI Plastics Test. Accordingly, an apparatus 105 treated with the protective coating 115 may be used in environments including, but not limited to, pharmaceutical manufacturing, computer and memory chip manufacturing, medical device manufacturing, clean room manufacturing, chemical manufacturing, and fluid storage, such as long term, high purity water storage.

The protective coating 115 may include multiple layers 120-130. In some embodiments, the protective coating 115 may include at least one primer layer 120 that may be applied onto a surface of the substrate. In some embodiments, the at least one primer layer 120 may include a partially halogenated material and polyphenylene sulfide (PPS). The partially halogenated material may include any partially halogenated material capable of operating according to some embodiments. Non-limiting examples of partially halogenated materials include ethylene tetrafluoroethylene (ETFE), polyvinylidene fluoride (PVDF), polytetrafluoroethylene (PTFE), ethylene chlorotrifluoroethylene (ECTFE), Kynar® PVDF produced by Arkema S.A. of Colombes, France, Halar® ECTFE produced by Solvay S.A. of Brussels, Belgium, Fluon® ETFE produced by AGC Chemicals Europe of Amsterdam, the Netherlands, and combinations thereof. In some embodiments, Fluon® TL-081, including about 10 micron to about 20 micron powdered ETFE, may be used for electrostatic applications. The PPS component may be formed from various grades of PPS, including Grade V-1 as measured by ASTM D 1238-65T. A non-limiting example of PPS is Ryton® produced by Chevron Phillips Chemical Company LLC of Woodlands, Tex., United States. In some embodiments, the grade and/or type of PPS may be selected to have a melt flow rate that corresponds with a melt flow rate of the partially halogenated material in order to, among other things, provide a homogeneous mixture for the applicable layer. In some embodiments, the PPS and/or partially halogenated materials may be formed as solid, micro-powder materials.

In some embodiments, only PPS and/or partially halogenated materials may be used to form the protective coating 115. For example, in some embodiments, the protective coating 115 may not include or may substantially not include any other materials besides PPS and/or partially halogenated materials, including to coarse materials, binders, adhesives, or the like.

In some embodiments, the at least one primer layer 120 may include about 0% by weight to about 20% by weight of the partially halogenated material and about 80% by weight to about 100% by weight of PPS. In some embodiments, the at least one primer layer 120 may include about 0% by weight of the partially halogenated material (for instance, the at least one primer layer includes no partially halogenated material or substantially no partially halogenated material), about 1% by weight, about 2% by weight, about 3% by weight, about 4% by weight, about 5% by weight, about 10% by weight, about 12% by weight, about 15% by weight, about 17% by weight, or about 20% by weight of the partially halogenated material, or any value or range between any two of these values (including endpoints). In some embodiments, the at least one primer layer 120 may include about 80% by weight of PPS, about 85% by weight, about 90% by weight, about 95% by weight, or about 100% by weight of PPS (for instance, the primer layer may consist of or substantially consist of PPS), or any value or range between any two of these values (including endpoints). In an embodiment in which the at least one primer coat consists of or substantially consists of PPS (for example, about 100% by weight of PPS), the PPS may include a Grade V-1 PPS. In an embodiment, in which the at least one primer coat consists of or substantially consists of PPS (for example, about 100% by weight of PPS), the PPS may include Grade P-6 PPS.

In some embodiments, the at least one primer layer 120 may be formed from a plurality of layers. For example, the at least one primer layer 120 may include 1 primer layer, 2 primer layers, 3 primer layers, 4 primer layers, 5 primer layers, 10 primer layers, or any value or range between any two of these values (including endpoints). In some embodiments including a plurality of primer layers 120, each of the primer layers may include the same concentration of the partially halogenated material and/or PPS. In some embodiments including a plurality of primer layers 120, one or more of the primer layers may include different concentrations of the partially halogenated material and/or PPS. In some embodiments including a plurality of primer layers, one or more of the primer layers may include a different partially halogenated material. For instance, a first primer layer 120 may include ECTFE, and a second primer layer may include ETFE.

In some embodiments, the at least one intermediate layer 125 may be applied onto the at least one primer layer 120. In some embodiments, the at least one intermediate layer 125 may be applied onto the top-most layer of an at least one primer layer 120 formed from multiple primer layers. In some embodiments, the at least one intermediate layer 125 may include about 60% by weight to about 80% by weight of the partially halogenated material and about 20% by weight to about 40% by weight of PPS. In some embodiments, the at least one intermediate layer 125 may include about 80% by weight of the partially halogenated material and about 20% by weight of PPS. In some embodiments, the at least one intermediate layer 125 may include about 65% by weight to about 70% by weight of the partially halogenated material and about 30% by weight to about 35% by weight of PPS. In some embodiments, the at least one intermediate layer 125 may include about 60% by weight, about 65% by weight of the, about 70% by weight, about 75% by weight, or about 80% by weight of the partially halogenated material, or any value or range between any two of these values (including endpoints). In some embodiments, the at least one intermediate layer 125 may include about 20% by weight, about 25% by weight, about 30% by weight, about 35% by weight, or about 40% by weight of PPS, or any value or range between any two of these values (including endpoints).

In some embodiments, the at least one intermediate layer 125 may be formed from a plurality of layers. For example, the at least one intermediate layer 125 may include 1 intermediate layer, 2 intermediate layers, 3 intermediate layers, 4 intermediate layers, 5 intermediate layers, 10 intermediate layers, or any value or range between any two of these values (including endpoints). In some embodiments including a plurality of intermediate layers 125, each of the intermediate layers may include the same concentration of the partially halogenated material and/or PPS. In some embodiments including a plurality of intermediate layers 125, one or more of the intermediate layers may include different concentrations of the partially halogenated material and/or PPS. In some embodiments including a plurality of intermediate layers, one or more of the intermediate layers may include a different partially halogenated material. For instance, a first intermediate layer 125 may include PVDF, and a second intermediate layer may include ECTFE.

In some embodiments, the at least one top layer 130 may be applied onto the at least one intermediate layer 125. In some embodiments, the at least one top layer 130 may be applied onto the top-most layer of an at least one intermediate layer 125 formed from a plurality of intermediate layers. In some embodiments, the at least one top layer 130 may include about 80% by weight to about 100% by weight of the partially halogenated material and about 0% by weight to about 20% by weight of PPS. In some embodiments, the at least one top layer 130 may include about 100% by weight of the partially halogenated material (for example, the at least one top layer 130 may consist of or may consist essentially of the partially halogenated material) and about 0% by weight of PPS (for instance, the at least one top layer includes no PPS or substantially no PPS). In some embodiments, the at least one top layer 130 may include about 80% by weight, about 85% by weight, about 90% by weight, about 95% by weight, or about 100% by weight of the partially halogenated material (for instance, consisting of or consisting substantially of the partially halogenated material), or any value or range between any two of these values (including endpoints). In some embodiments, the at least one top layer 130 may include about 0% by weight of PPS (for instance, the at least one top layer includes no PPS or substantially no PPS), about 5% by weight, about 10% by weight, about 15% by weight, about 20% by weight of PPS, or any value or range between any two of these values (including endpoints). In an embodiment, the top layer 130 may include about 80% by weight to about 95% by weight of ETFE and about 5% by weight to about 20% by weight of PTFE.

In some embodiments, the top layer may include a pigment formed from a partially halogenated pigment material. For example, the partially halogenated pigment material may include about 5% by weight to about 18% by weight of PTFE. In another example, the partially halogenated pigment material may be at least partially formed from Dyneon™ J14 PTFE produced by the 3M Company of St. Paul, Minn., United States. In one non-limiting example, some embodiments including Grade V-1 PPS may include Dyneon™ J14 PTFE. In some embodiments using Grade V-1 PPS and Dyneon™ J14 PTFE, the Dyneon™ J14 PTFE may be about 0% to about 5% by weight of the layer. In some embodiments, Grade V-1 PPS and Dyneon™ J14 PTFE may be used in a primer layer 120.

In some embodiments, the at least one top layer 130 may be formed from a plurality of layers. For example, the at least one top layer 130 may include 1 top layer, 2 top layers, 3 top layers, 4 top layers, 5 top layers, 10 top layers, or any value or range between any two of these values (including endpoints). In some embodiments including a plurality of top layers 130, each of the top layers may include the same concentration of the partially halogenated material and/or PPS. In some embodiments including a plurality of top layers 130, one or more of the top layers may include different concentrations of the partially halogenated material and/or PPS. In some embodiments including a plurality of top layers, one or more of the top layers may include a different partially halogenated material. For instance, a first top layer 130 may include ETFE, and a second primer layer may include PVDF.

In some embodiments, the at least one primer layer 120 may include 2 primer layers, the at least one intermediate layer 125 may include 1 intermediate layer, and the at least one top layer 130 may include 2 top layers. In some embodiments, the protective coating may be about 760 microns (about 30 mil (1 mil=1/1000 of an inch)) thick. In some embodiments, the protective coating may be about 250 microns (about 10 mil) to about 1270 microns (about 50 mil) thick. In some embodiments, the protective coating may have a thickness of about 130 microns (about 5 mil), about 180 microns (about 7 mil), about 250 microns (about 10 mil), about 300 microns (about 12 mil), about 380 microns (about 15 mil), about 500 microns (about 20 mil), about 635 microns (about 25 mil), about 760 microns (about 30 mil), about 889 microns (about 35 mil), about 1016 microns (about 40 mil), about 1140 microns (about 45 mil), about 1270 microns (about 50 mil), about 2540 microns (about 100 mil), or any value or range between any two of these values (including endpoints).

The protective coating 115, including the layers 120-130 thereof, may be applied to the surface of the substrate 110 using various methods. For example, the protective coating may be applied by brushing, spraying, wiping, fluidized bed applications, and/or an electrostatic powder coating process. A non-limiting example of an electrostatic powder coating process may use a PrimaSprint Airfluid electrostatic powder coating machine produced by Wagner Systems of Elgin, Ill., United States. In some embodiments, one or more of the components for forming the protective coating 115 may be in the form of micro-powders that may be fluidized with air and then flocked onto preheated and electrically-charged substrates 110. In some embodiments, substrates 110 being coated with the protective coating 115 may be rotated during application of the layers of the protective coating and curing thereof to ensure, among other things, an even coating of the substrate. In some embodiments, a kit may be configured to provide components for forming the protective coating 115. For example, the kit may include components for forming and/or applying at least one primer layer, at least intermediate layer, and at least one top layer.

The protective coating 115 may be configured to provide a physical barrier to the surface of the substrate 110. For example, the protective coating 115 may be configured to reduce or eliminate exposure of the substrate 110 to chemicals, heat, gas, moisture, steam, or any other substance or form of energy capable of corroding or otherwise damaging the substrate and/or surfaces thereof. In some embodiments, the protective coating 115 may be configured to pass a USP Class VI Plastics Test. In some embodiments, the protective coating may pass the USP Class VI Plastics Test when extracted at about 50° C. for about 72 hours with a 7-day implant in a vessel or apparatus.

In some embodiments, the protective coating 115 may be configured to be resistant to steam at a pressure of about 15 pounds per square inch for a duration of at least about 24 hours to at least about 216 hours. Resistance to steam under such conditions for up to 216 hours means, among other things, that the protective coating 115 may have a service life of about 20 years.

Accordingly, some embodiments provide protective coatings 115 that are versatile, tough, inexpensive, inert and impermeable and that meet the requirements of a wide range of process environments. Non-limiting examples of process environments include pharmaceutical manufacturing, medical device manufacturing, computer and memory chip manufacturing, a clean room, a chemical mixing tank, processing equipment, piping, a holding tank, a product or manufacturing surface, an implant, or the like. Protective coatings 115 configured according to some embodiments may be used in environments using conventional partially halogenated coatings and conventional application techniques. As such, the use and application of protective coatings 115 configured according to some embodiments require no retraining of personnel or process changes. Protective coatings 115 configured according to some embodiments may require less material, and lower utility and resource cost, while providing a thin-film partially halogenated coating with improved steam and chemical resistance.

In some embodiments, the protective coating 115 may be configured as a “release coating” or “non-stick” coating. In an embodiment in which the protective coating 115 is configured as a “non-stick” coating, the protective coating may include one or more layers that include about 20% to about 80% by weight of PPS, about 20% to about 80% by weight of a partially halogenated material, and about 5% to about 20% by weight of PTFE. In some embodiments, the “non-stick” protective coating 115 may include 1 layer. In some embodiments, the “non-stick” protective coating 115 may include 1 layer, 2 layers, 3 layers, 4 layers, or 5 layers.

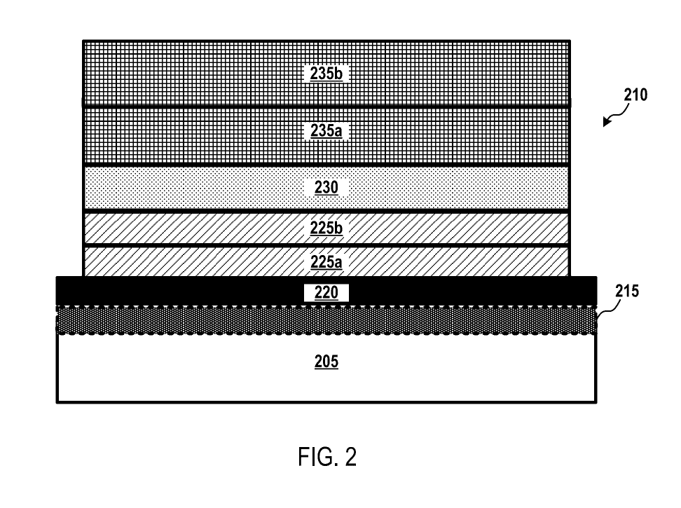

FIG. 2 depicts an illustrative substrate having a protective coating formed thereon according to some embodiments. As shown in FIG. 2, a substrate 205 may have a protective coating 210 formed thereon. In some embodiments, the substrate 205 may be prepared before being coated with the protective coating 210. For instance, the substrate 205 may be sandblasted, cleaned (for example, using a solvent), and heated to a preheat temperature. For example, the substrate 205 may be heated to a preheat temperature of about 250° C. to about 350° C. In FIG. 2, the upper surface 215 of the substrate 205 has been sandblasted and cleaned with a solvent to facilitate coating with a material. In some embodiments, the substrate 205 may be coated with a pre-primer layer 220 to facilitate adhesion of the primer layer 225a to the substrate. In some embodiments, the pre-primer layer 220 may include a cobalt oxide primer layer. Two primer layers 225a, 225b may be applied to the substrate 205, the first of which is applied directly on the pre-primer layer 220. An intermediate layer 230 may be applied on the second primer layer 225b (for instance, the top-most primer layer). A first top layer 235a may be applied onto the intermediate layer 230 and a second top layer 235b may be applied onto the first top layer.

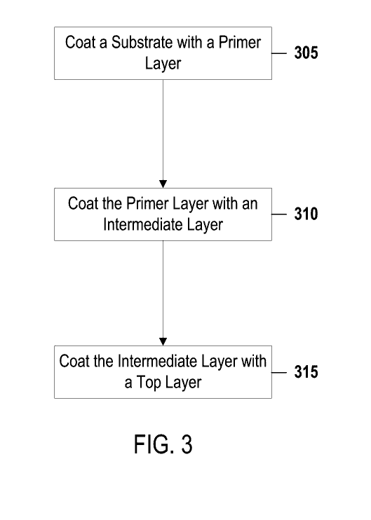

FIG. 3 depicts a flow diagram for an illustrative method of forming a protective coating according to a first embodiment. As shown in FIG. 3, a substrate may be coated 305 with a primer layer. In some embodiments, the primer layer may include a plurality of primer layers. In some embodiments, the primer layer may include PPS. In some embodiments, the primer layer may consist essentially of PPS, including Grade V-1 PPS. In some embodiments, the primer layer may include PPS and a partially halogenated material, such as ETFE, PVDF, PTFE, ECTFE, Kynar®, Halar® Fluon®, or any combination thereof.

The primer layer may be coated 310 with an intermediate layer. The intermediate layer may include a partially halogenated material and PPS. In some embodiments, the intermediate layer may include about 60% by weight to about 80% by weight of the partially halogenated material and about 20% by weight to about 40% by weight of PPS. In some embodiments, the intermediate layer may include PPS and a partially halogenated material, such as ETFE, PVDF, PTFE, ECTFE, Kynar®, Halar® Fluon®, or any combination thereof. The intermediate layer may be coated 315 with a top layer. In some embodiments, the top layer may include multiple top layers. In some embodiments, the top layer may include PPS and a partially halogenated material. In some embodiments, the top layer may include about 0% PPS (for example, the top layer may include or substantially include no PPS) and may include about 100% by weight of the partially halogenated material (for example, the top layer may consist of or consist essentially of the partially halogenated material). In some embodiments, the partially halogenated material may include ETFE, PVDF, PTFE, ECTFE, Kynar®, Halar® Fluon®, or any combination thereof.

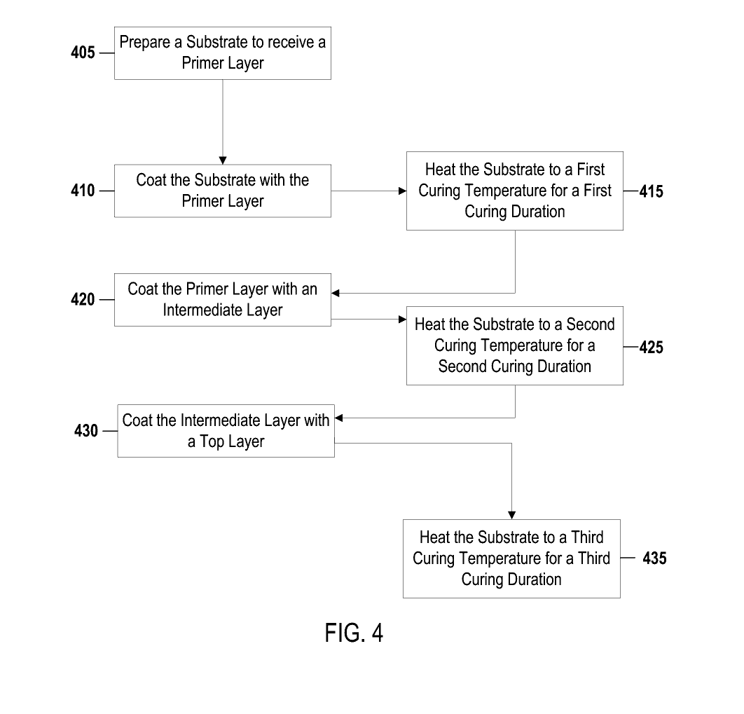

FIG. 4 depicts a flow diagram for an illustrative method of forming a protective coating according to a second embodiment. As shown in FIG. 4, a substrate may be prepared 405 to receive a primer layer. In some embodiments, the substrate may be prepared 405 by increasing the abrasiveness of a surface of the substrate, for example, by sandblasting. In some embodiment, the substrate may be prepared 405 by cleaning a surface of the substrate with a solvent. In some embodiments, the substrate may be prepared 405 by heating the substrate to a preheat temperature. For example, the substrate may be heated to about 250° C. to about 350° C.

The substrate may be coated 410 with the primer layer. After the substrate has been coated 410 with the primer layer, the substrate may be heated 415 to a first curing temperature for a first curing duration. In some embodiments, the first curing temperature may be about 250° C. to about 350° C. In some embodiments, the first curing duration may be about 5 minutes to about 25 minutes. In some embodiments, the primer layer may include a plurality of primer layers. In some embodiments including a plurality of primer layers, the substrate may be heated 415 after each coating 410 of all or some of the primer layers.

The primer layer may be coated 420 with an intermediate layer. After the primer layer has been coated 420 with the intermediate layer, the substrate may be heated 425 to a second curing temperature for a second curing duration. In some embodiments, the second curing temperature may be about 250° C. to about 350° C. In some embodiments, the second curing duration may be about 10 minutes to about 30 minutes. In some embodiments, the intermediate layer may include a plurality of intermediate layers. In some embodiments including multiple intermediate layers, the substrate may be heated 425 after each coating 420 of all or some of the intermediate layers.

The intermediate layer may be coated 430 with a top layer. After the intermediate layer has been coated 430 with the top layer, the substrate may be heated 435 to a third curing temperature for a third curing duration. In some embodiments, the third curing temperature may be about 225° C. to about 325° C. In some embodiments, the third curing duration may be about 5 minutes to about 25 minutes. In some embodiments, the top layer may include a plurality of top layers. In some embodiments including multiple top layers, the substrate may be heated 435 after each coating 430 of all or some of the top layers.

### EXAMPLES

### Example 1

### Reduction of Corrosion of an Aluminum Substrate

An aluminum substrate about 0.25 inches (6.35 millimeters) thick is sandblasted, cleaned with solvent and preheated to about 297° C. for about one hour. An electrostatic powder coating machine is used to apply a first primer layer that consists essentially of Ryton® PPS and that does not include a partially halogenated material (for example, a first partially halogenated material). The first primer layer is about 50 microns (about 2 mil) thick. The aluminum substrate is hung on an electrically conductive rack using metal wire hangers during application of the layers of the protective coating and is placed in a convention oven during curing. After application of the first primer layer, the aluminum substrate is heated to about 297° C. for about 10 minutes. A second primer layer that consists essentially of Ryton® PPS and that does not include a partially halogenated material (for example, a first partially halogenated material) is applied onto the first primer layer using the electrostatic powder coating machine. The second primer layer is about 130 microns (about 5 mil) thick. The aluminum substrate is heated to about 297° C. for about 15 minutes.

An intermediate layer including a partially halogenated material (for example, a second partially halogenated material) that includes about 70% by weight of a Fluon® partially halogenated material and about 30% by weight of Ryton® PPS is applied onto the second primer layer. The aluminum substrate is heated to about 277° C. for about 15 minutes. The intermediate layer is about 250 (about 10 mils) thick.

A first top layer consisting essentially of a partially halogenated material (for example, a third partially halogenated material) that includes about 100% by weight of a Fluon® partially halogenated material is applied onto the intermediate layer. The aluminum substrate is heated to about 277° C. for about 15 minutes. The first top layer is about 100 microns (about 4 mil) thick. A second top layer consisting essentially of a partially halogenated material (for example, a third partially halogenated material) that includes about 100% by weight of a Fluon® partially halogenated material is applied onto the first top layer. The aluminum substrate is heated to about 277° C. for about 20 minutes. The second top layer is about 230 microns (about 9 mil) thick such that the protective layer is about 760 microns (about 30 mils) thick. The aluminum substrate is cured under room temperature and pressure for about 72 hours. Table 1, below, includes the components of the protective coating used to coat the aluminum substrate.

The aluminum substrate coated with the protective coating is incorporated as the inner surface of a vessel used in a high-temperature steam environment for sterilizing components of a pharmaceutical manufacturing process. The protective coating on the aluminum substrate is configured to protect the inner surface of the vessel from corrosion and damage from steam and high temperatures. The protective coating increases the lifespan of similar vessels treated with conventional coatings by about 20 times, leading to decreased cost and increased uptimes for the pharmaceutical manufacturing process.

TABLE 1
Protective Layer of Example 1

| | | | | | Percent (%) |
|---|---|---|---|---|---|
| | | Percent | Type of | Category of | by Weight |
| | | (%) by | Partially | Partially | of Partially |
| Protective Coating | Type of | Weight of | Halogenated | Halogenated | Halogenated |
| Layer | PPS | PPS | Material | Material | Material |
| First Primer Layer | Ryton ® | 100 | None | First | 0 |
| | | | | Partially | |
| | | | | Halogenated | |
| | | | | Material | |
| Second Primer | Ryton ® | 100 | None | First | 0 |
| Layer | | | | Partially | |
| | | | | Halogenated | |
| | | | | Material | |
| Intermediate | Ryton ® | 30 | Fluon ® | Second | 70 |
| Layer | | | | Partially | |
| | | | | Halogenated | |
| | | | | Material | |
| First Top Layer | None | 0 | Fluon ® | Third | 100 |
| | | | | Partially | |
| | | | | Halogenated | |
| | | | | Material | |
| Second Top Layer | None | 0 | Fluon ® | Third | 100 |
| | | | | Partially | |
| | | | | Halogenated | |
| | | | | Material | |

### Example 2

### Reduction of Chemical Damage to Storage Tank

An oil refinery uses sulfuric acid in the oil refining process. Conventional sulfuric acid storage vessels at the oil refinery facilities have a relatively short lifespan as the inner surfaces thereof are degraded due to chemical damage from the highly reactive sulfuric acid. The conventional sulfuric acid storage vessels were coated with ethylene tetrafluoroethylene (ETFE 1020™) produced by the Fisher Company of North Salt Lake, Utah, United States. The ETFE coating required 25 applications, each with a 277° C. curing cycle, generating a coating with a thickness of 2540 microns (100 mil). The ETFE coating is only guaranteed to protect a sulfuric acid storage vessel for 1 year. The total material cost to coat a sulfuric acid storage vessel using ETFE is about USD $1,800.

A new and alternative sulfuric acid storage vessel is incorporated into the sulfuric acid delivery system. The new sulfuric acid storage vessel is formed from stainless steel and is about 2 meters wide, about 3 meters high, and has a circumference of about 3 meters. The inner surface of the new sulfuric acid storage vessel is lined with a protective coating. The protective coating includes 3 primer layers. The first and second primer layers consist essentially of PPS and are each about 75 microns (about 3 mil) thick (the first primer layer is the primer layer closest to the inner surface). The first and second primer layers do not include a partially halogenated material (for example, a first partially halogenated material). The third primer layer includes about 80% by weight of PPS and about 20% by weight of an ETFE partially halogenated material (for example, a first partially halogenated material).

The third primer layer is coated with 2 intermediate layers that include about 70% by weight of a partially halogenated material (for example, a second partially halogenated material) and about 30% by weight of PPS. The partially halogenated material of the intermediate layers (for example, the second partially halogenated material) includes about 50% by weight of an ETFE partially halogenated material and about 50% by weight of a PVDF partially halogenated material. Each intermediate layer is about 100 microns (about 4 mil) thick.

The top-most intermediate layer is coated with a top layer that includes 3 top layers. The first top layer includes about 15% by weight of PPS and about 85% by weight of a partially halogenated material (for example, a third partially halogenated material) (the first top layer is the top layer closest to the top-most intermediate layer). The first top partially halogenated material includes about 20% by weight of an ETFE partially halogenated material and about 80% by weight of a PVDF partially halogenated material. The second and third top layers consist essentially of about 100% of a PVDF partially halogenated material (for example, a third partially halogenated material).

Table 2, below, includes the components of the protective coating used to coat the sulfuric acid storage vessel. The total material cost to coat a sulfuric acid storage vessel using the protective coating is about USD $600, one third of the material cost of the ETFE 1020™ coating.

The protective coating within the new sulfuric acid storage vessel requires fewer materials and less labor to protect the inner surface of the stainless steel storage vessel. In addition, the protective coating substantially reduces the exposure of the inner surface of the vessel to the sulfuric acid and will have a lifespan that is approximately 10 times the lifespan of sulfuric acid storage vessels that are coated using conventional techniques and materials, further decreasing the lifetime operating cost of the storage vessel.

TABLE 2
Protective Layer of Example 2

| | | | | | Percent (%) |
|---|---|---|---|---|---|
| | | Percent | Type of | Category of | by Weight |
| | | (%) by | Partially | Partially | of Partially |
| Protective Coating | Type of | Weight of | Halogenated | Halogenated | Halogenated |
| Layer | PPS | PPS | Material | Material | Material |
| First Primer Layer | PPS | 100 | None | First | 0 |
| | | | | Partially | |
| | | | | Halogenated | |
| | | | | Material | |
| Second Primer | PPS | 100 | None | First | 0 |
| Layer | | | | Partially | |
| | | | | Halogenated | |
| | | | | Material | |
| Second Primer | PPS | 80 | ETFE | First | 20 |
| Layer | | | | Partially | |
| | | | | Halogenated | |
| | | | | Material | |
| First | PPS | 30 | ETFE and | Second | 35% by |
| Intermediate | | | PVDF | Partially | weight |
| Layer | | | | Halogenated | ETFE and |
| | | | | Material | 35% by |
| | | | | | weight |
| | | | | | PVDF) |
| Second | PPS | 30 | ETFE and | Second | 70 (35% by |
| Intermediate | | | PVDF | Partially | weight |
| Layer | | | | Halogenated | ETFE and |
| | | | | Material | 35% by |
| | | | | | weight |
| | | | | | PVDF) |
| First Top Layer | PPS | 15 | ETFE and | Third | 85 (17% by |
| | | | PVDF | Partially | weight |
| | | | | Halogenated | ETFE and |
| | | | | Material | 68% by |
| | | | | | weight |
| | | | | | PVDF) |
| Second Top Layer | None | 0 | PVDF | Third | 100 |
| | | | | Partially | |
| | | | | Halogenated | |
| | | | | Material | |
| Third Top Layer | None | 0 | PVDF | Third | 100 |
| | | | | Partially | |
| | | | | Halogenated | |
| | | | | Material | |

### Example 3

### Preparation of Protective Coating Layers

A protective coating is prepared having two primer layers, one intermediate layer, and two top layers. The primer layers are formed by adding 20 grams of ETFE and 80 grams of Grade V-1 PPS to a 200 mL container and thoroughly mixing the ETFE and PPS to form a primer layer solution. The intermediate layer is formed by adding about 66 grams of ETFE and 34 grams of Grade V-1 PPS to a 200 mL container and thoroughly mixing the ETFE and PPS to form an intermediate layer solution. The top layer consists essentially of ETFE. The protective coating is sufficient to coat about 0.09 square meters of a substrate with at least 2 primer layers, an intermediate layer, and a plurality of top layers.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein can be readily broken down into a lower third, a middle third, and an upper third. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of coating a substrate to protect a surface thereof, the method comprising:
coating the surface with at least one primer layer comprising about 0% by weight to about 20% by weight of a first partially halogenated material and about 80% by weight to about 100% by weight of polyphenylene sulfide;
coating the at least one primer layer with at least one intermediate layer comprising about 60% by weight to about 80% by weight of a second partially halogenated material and about 20% by weight to about 40% by weight of polyphenylene sulfide; and
coating the at least one intermediate layer with at least one top layer comprising about 80% by weight to about 100% by weight of a third partially halogenated material and about 0% by weight to about 20% by weight of polyphenylene sulfide.

2. The method of claim 1, wherein coating one or more of the surface, the at least one primer layer and the at least one intermediate layer comprises coating with one or more of the first partially halogenated material, the second partially halogenated material, and the third partially halogenated material being independently selected from at least one of ethylene tetrafluoroethylene, polyvinylidene fluoride, polytetrafluoroethylene, and ethylene chlorotrifluoroethylene.

3.-7. (canceled)

8. The method of claim 1, further comprising heating the surface to a preheat temperature of about 250° C. to about 350° C. before coating the surface with the at least one primer layer.

9.-13. (canceled)

14. The method of claim 1, further comprising coating the surface with at least one cobalt oxide layer.

15. (canceled)

16. The method of claim 1, wherein coating the surface with the first partially halogenated material, coating the at least one primer layer with the second partially halogenated material and coating the at least one intermediate layer with the third partially halogenated material each comprises coating with ethylene tetrafluoroethylene.

17.-19. (canceled)

20. The method of claim 1, wherein coating the surface comprises coating with at least one primer layer having about 20% by weight of the first partially halogenated material and about 80% by weight of polyphenylene sulfide, and wherein the first partially halogenated material is ethylene tetrafluoroethylene.

21. The method of claim 1, wherein coating the at least one primer layer comprises coating with at least one intermediate layer having about 65% by weight to about 70% by weight of the second partially halogenated material and about 30% by weight to about 35% by weight of polyphenylene sulfide, and wherein the second partially halogenated material is ethylene tetrafluoroethylene.

22. The method of claim 1, wherein coating the at least one intermediate layer comprises coating with at least one top layer having about 100% by weight of the third partially halogenated material and substantially 0% by weight of polyphenylene sulfide, and wherein the third partially halogenated material is ethylene tetrafluoroethylene.

23. The method of claim 1, wherein coating the at least one intermediate layer comprises coating with a third partially halogenated material including about 80% to about 95% by weight ethylene tetrafluoroethylene and about 5% to about 20% polytetrafluoroethylene.

24.-25. (canceled)

26. The method of claim 1, wherein coating the surface comprises coating at least one of aluminum, steel, stainless steel, iron, a ceramic material, and alloys thereof.

27. (canceled)

28. The method of claim 1, wherein coating the substrate comprises coating with at least one primer layer, the at least one intermediate layer, and the at least one top layer to form a coating that is about 250 microns to about 1270 microns thick.

29.-54. (canceled)

55. A method of forming a protective coating, the method comprising:
providing at least one primer layer comprising about 0% by weight to about 20% by weight of a first partially halogenated material and about 80% by weight to about 100% by weight of polyphenylene sulfide;
providing at least one intermediate layer on the at least one primer layer, the at least one intermediate layer comprising about 60% by weight to about 80% by weight of a second partially halogenated material and about 20% by weight to about 40% by weight of polyphenylene sulfide;
providing at least one top layer on the at least one intermediate layer, the at least one top layer comprising about 80% by weight to about 100% by weight of a third partially halogenated material and about 0% by weight to about 20% by weight of polyphenylene sulfide; and
forming the at least one primer layer, the at least one intermediate layer, and the at least one top layer into the protective coating.

56. The method of claim 55, wherein providing at least one primer layer, providing at least one intermediate layer, and providing at least one top layer comprise providing the first partially halogenated material, the second partially halogenated material, and the third partially halogenated material being independently selected from at least one of ethylene tetrafluoroethylene, polyvinylidene fluoride, polytetrafluoroethylene, and ethylene chlorotrifluoroethylene.

57.-60. (canceled)

61. The method of claim 55, further comprising heating each of the at least one primer layer, the at least one intermediate layer and at least one top layer to a temperature of about 225° C. to about 350° C. for a duration of about 5 minutes to about 30 minutes.

62.-63. (canceled)

64. The method of claim 55, further comprising providing at least one primer layer comprises providing a cobalt oxide layer.

65. The method of claim 55, wherein providing at least one primer layer having the first partially halogenated material, providing at least one intermediate layer having a second partially halogenated material, and providing at least one top layer have a third partially halogenated material each comprises providing ethylene tetrafluoroethylene.

66.-68. (canceled)

69. The method of claim 55, wherein providing the at least one primer layer comprises providing about 20% by weight of the first partially halogenated material and about 80% by weight of polyphenylene sulfide, and wherein the first partially halogenated material is ethylene tetrafluoroethylene.

70. The method of claim 55, wherein providing the at least one intermediate layer comprises providing about 65% by weight to about 70% by weight of the second partially halogenated material and about 30% by weight to about 35% by weight of polyphenylene sulfide, and wherein the second partially halogenated material is ethylene tetrafluoroethylene.

71. The method of claim 55, wherein providing the at least one top layer comprises providing about 100% by weight of the third partially halogenated material and substantially 0% by weight of polyphenylene sulfide, and wherein the third partially halogenated material is ethylene tetrafluoroethylene.

72. The method of claim 55, wherein providing the at least one top layer comprises providing the third partially halogenated comprising ethylene tetrafluoroethylene and polytetrafluoroethylene.

73. The method of claim 72, wherein providing the at least one top layer comprises providing about 80% by weight to about 95% by weight of ethylene tetrafluoroethylene and about 5% by weight to about 20% by weight of polytetrafluoroethylene.

74.-75. (canceled)

76. A protective coating comprising:
at least one primer layer comprising about 0% by weight to about 20% by weight of a first partially halogenated material and about 80% by weight to about 100% by weight of polyphenylene sulfide;
at least one intermediate layer comprising about 60% by weight to about 80% by weight of a second partially halogenated material and about 20% by weight to about 40% by weight of polyphenylene sulfide; and
at least one top layer comprising about 80% by weight to about 100% by weight of a third partially halogenated material and about 0% by weight to about 20% by weight of polyphenylene sulfide.

77. The protective coating of claim 76, wherein the first partially halogenated material, the second partially halogenated material, and the third partially halogenated material are independently selected from at least one of ethylene tetrafluoroethylene, polyvinylidene fluoride, polytetrafluoroethylene, and ethylene chlorotrifluoroethylene.

78.-83. (canceled)

84. The protective coating of claim 76, further comprising at least one cobalt oxide primer layer.

85. (canceled)

86. The protective coating of claim 76, wherein one or more of the first partially halogenated material, the second partially halogenated material, and the third partially halogenated material comprise ethylene tetrafluoroethylene.

87.-89. (canceled)

90. The protective coating of claim 76, wherein the at least one primer layer comprises about 20% by weight of the first partially halogenated material and about 80% by weight of polyphenylene sulfide, and wherein the first partially halogenated material is ethylene tetrafluoroethylene.

91. The protective coating of claim 76, wherein the at least one intermediate layer comprises about 65% by weight to about 70% by weight of the second partially halogenated material and about 30% by weight to about 35% by weight of polyphenylene sulfide, and wherein the second partially halogenated material is ethylene tetrafluoroethylene.

92. The protective coating of claim 76, wherein the at least one top layer comprises about 100% by weight of the third partially halogenated material and substantially 0% by weight of polyphenylene sulfide, and wherein the third partially halogenated material is ethylene tetrafluoroethylene.

93. The protective coating of claim 76, wherein the third partially halogenated material comprises ethylene tetrafluoroethylene and polytetrafluoroethylene.

94. The protective coating of claim 93, wherein the third partially halogenated material comprises about 80% by weight to about 95% by weight of ethylene tetrafluoroethylene and about 5% by weight to about 20% by weight of polytetrafluoroethylene.

95.-96. (canceled)

97. The protective coating of claim 76, wherein the protective coating is about 250 microns to about 1270 microns thick.

98.-109. (canceled)
